(19) United States
(12) Patent Application Publication
(10) Pub. No.: US 2024/0196929 A1
(43) Pub. Date: Jun. 20, 2024

(54) Using fruit oil immersion including Olea europaea Olive oil varietals to preserve and stabilize Bromoform products from the red seaweed Asparagopsis armata and Asparagopsis taxiformis applied as a livestock feed supplement to reduce enteric methane

(71) Applicant: Roger Peters Garth Bason, Red Hook, NY (US)

(72) Inventor: Roger Peters Garth Bason, Red Hook, NY (US)

(21) Appl. No.: 18/083,044

(22) Filed: Dec. 16, 2022

(51) Int. Cl. A23K 10/30; A23K 20/158; A23K 50/10

(52) U.S. Cl. CPC A23K 10/30; A23K 20/158; A23K 50/10

(57) ABSTRACT

Methane is a potent greenhouse gas (GHG), with more than 80 times the global warming impact of carbon dioxide during its first 10 to 20 years after release into the earth's atmosphere. This patent presents a unique method for climate action and reduction of GHGs using fruit oils to stabilize and preserve volatile bromoform compounds that are a key ingredient in a livestock feed supplement that reduces enteric methane produced by ruminants. Bromoform compounds are extracted from the red seaweed Asparagopsis using a method comprised of harvesting, water washing, spin drying, and homogenizing the seaweed with a fruit oil including Olive, Coconut or Argan oil in a proportion of biomass to oil of 1.2 to 1.0. This enables effective stabilization of the bromoform and optimal performance as a feed supplement when ingested by ruminants to reduce enteric methane emissions in livestock.

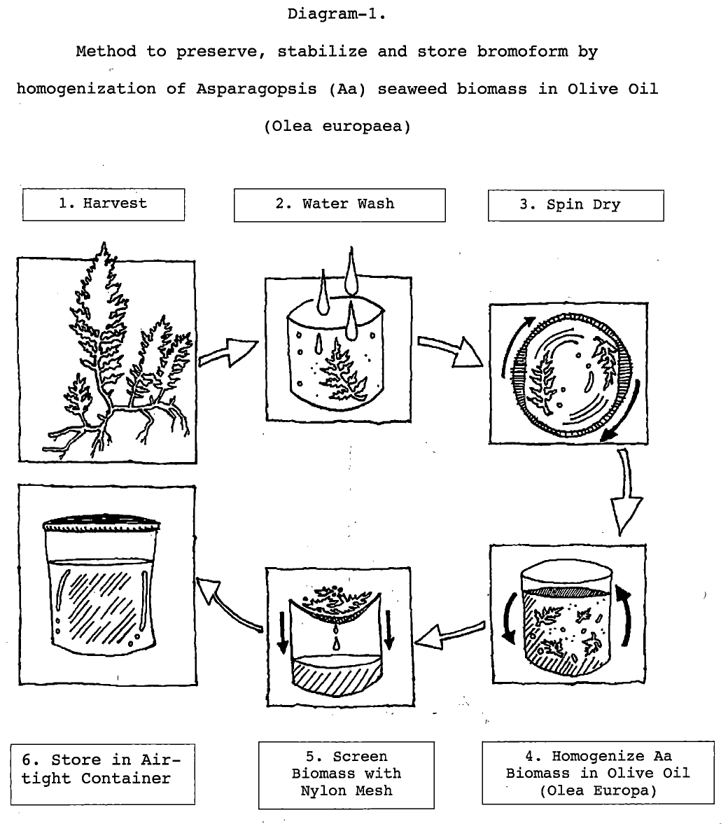

### REFERENCE

Magnusson, Marie et al. “Using oil immersion to deliver a naturally-derived, stable bromoform product from the red seaweed Asparagopsis taxiformis” Algal Research, 19 Mar. 2020.

### BRIEF SUMMARY OF THE INVENTION

This invention presents a novel process, method and material for preserving and stabilizing bromoform compounds extracted from the red seaweed species of Asparagopsis armata and Asparagopsis taxiformis in order to produce a livestock feed supplement that reduces methane emissions. When this red seaweed is harvested, washed, and homogenized in fruit oil, this method extracts key methane-reducing ingredients consisting of organic bromoform compounds that remain stored and stable as a seaweed-fruit oil infusion. This infusion is the creation of a new substance due to the process of homogenization of the two ingredients, (seaweed and fruit oil) and the unique chemical properties of the bromoform compounds in the seaweed that are captured and stored within the fruit oil infusion. This process is effective using fruit oils from the olive tree (Olea europaea) fruit and its varietals as well as other fruit oils including coconut and argan oils. While past approaches have used vegetable oil to extract and infuse Asparagopsis seaweeds this novel approach uses fruit oils. These fruits are grown and fruit oils are produced in regions with an abundant supply of Asparagopsis in near shore ocean environments. The geographical proximity of the two key ingredients reduces the carbon footprint of the supply chain that enhances its low-carbon value and overall economic efficiency for mass production. Over three (3) billion ruminants in the world contribute approximately 44% of global methane emissions. Methane is considered a highly toxic Green House Gases (GHGs) that is 86× as potent as CO2. Methane from ruminants contributes about 30% of non-geologic sources of global warming. Due to these factors the proposed invention can have a positive impact by reducing the many threats of climate change and do so in a relatively rapid manner, subject to its scale and cost-effective application.

### BACKGROUND

Global warming presents an existential threat to the health of planetary ecosystems and the sustainable future of humanity. Efforts to reduce Greenhouse Gases (GHGs) are therefore of critical importance to advance climate action and reduce negative planetary impacts. One of the fastest approaches to mitigate this threat is the reduction of methane gas emissions. Methane has an impact on global warming that is over 80-times the short-term impact of carbon dioxide. Methane is a powerful GHG and has contributed approximately 30% of all global warming since pre-industrial times and is now proliferating worldwide faster than at any time since recordkeeping began in the 1980's.

A key contributor of methane increase is enteric methane generated from ruminant livestock which is released daily from the world's 1.5 billion cattle, 1.2 billion sheep, 1.0 billion goats, approximately 40 million camels. The proposed novel art presents a seaweed and fruit-oil infusion that can be added as a feed supplement to reduce enteric methane in livestock. If this approach is applied as a livestock feed supplement and is widely adopted; it can reduce daily methane output from the world's ruminant livestock and help reduce the threat and disruptive impacts of climate change.

The methane reducing qualities of the seaweed and fruit oil infusion livestock feed supplement can provide rapid results as it can be effectively delivered within one (1) day of the seaweed harvest, processing, packaging, transport and delivery. This approach is, clearly among the most rapid, proven, immediate solutions available for significant methane reduction worldwide. It is not only an effective approach but also one of the fastest, most secure actions now available to contribute to the reversal or mitigation of GHG climate impacts. The inventor (CEO) and staff of Atlantic Ocean Aquaculture has tested this approach using seaweed harvested in Sagres, Portugal on Mar. 30, 2022. The wild harvested Asparagopsis seaweed was processed using this method and tested at an independent laboratory in the US (Bigelow Analytical Services, East Boothbay, Maine) to have effectively extracted over 90% of the bromoform compounds from the seaweed biomass into the olive oil within 36 hours of the ocean harvest.

The methane reducing qualities of Asparagopsis seaweeds has been clearly demonstrated by research conducted in the United States (Roche, 2021), Australia (Kinley, 2020) and New Zealand over the past 7 years. (2015-2022). This patent application proposes a novel method and approach to developing and delivering an effective livestock feed supplement to ruminant livestock. It consists of a specific method that includes homogenization of the either Asparagopsis armata (Aa) or Asparagopsis taxiformis (At) biomass in a fruit oil immersion in specific proportions. Previous approaches have been based on vegetable oil solutions (Magnusson, 2020). A novel approach presented in this utility patent is the use of fruit oil and the manner in which the seaweed is infused in the fruit oil.

Seaweeds act like organic bio-refineries as they naturally extract and metabolize a broad range of specific chemical elements and compounds from seawater. As many seaweeds are commonly exposed to varying, diverse and often harsh environmental conditions, they produce a broad range of complex organic chemical metabolites some of which provide protection from biotic and environmental stress factors. These metabolites protect seaweeds from biotic factors that also include marine bacteria and viruses and from harsh environmental conditions such as intense sunlight, temperature variations, storm surge and excessive wave action.

The development of seaweed metabolite content and diversity is subject to biotic factors, such as species, life stage, size, age, reproductive status, and environmental factors including location depth, nutrient enrichment, salinity, light intensity exposure, ultraviolet radiation, intensity of herbivory, and time of day at collection; thus, the full exploitation of algal diversity and complexity requires knowledge of environmental impacts and an understanding of biochemical and biological variability and factors that influence this variability regarding wild harvest location and time of year.

Metabolites that are effective in reducing enteric methane that are produced by Asparagopsis armata (Aa) and Asparagopsis taxiformis (At) consist of compounds containing Bromine (Br) that generally include Bromoform (CHBr₃), Dibromo Chloro Methane (CHBr₂Cl), Bromo Chloro Acetic Acid (C₂H₂BrClO₂), Dibromo Acetic Acid (CH₃COOH), and Dibromo Acrylic Acid (C₃H₄Br₂O₂). However more detailed analytics include additional key compounds (Felix, 2021) found in halogenated volatile organic compounds (HVOCs) present in the gametophyte stage of Asparagopsis armata in the form of 44 different bromoform compounds including alkanes (9), alcohols (2), carboxylic acids (5), ketones (19) acrylic acids (7), and aldehydes (2). These compounds containing Br effectively disrupt the production of methane in livestock rumen when fed in small micro doses on a daily basis. These Bromoform compounds when properly administered comprise less than 1% dry weight of the ruminant daily feed regime.

Halogenated compounds, which are defined by the presence of chlorine, iodine, fluorine, and bromine, are biologically active chemicals often with beneficial properties to humans- and animals. For example, bromoform (CHBr3) has antibacterial and antifungal properties mitigating the proliferation of Pseudomonas aeruginosa, Escherichia coli, Candida albicans, and Staphylococcus aureus, which occur in humans.

Halogenated methane analogues such as bromoform, dibromochloromethane (CHBr2Cl), and bromochloromethane (CH2BrCl) have anti-methanogenic properties and reduce the production of enteric methane in ruminants by inhibiting an essential enzymatic reaction required by methanogenic archaea, thus halting the formation of methane and increasing productivity, with a concomitant decrease, but not an elimination, of methanogenic archaea in the rumen.

Of these examples, the highest bioactivity indicated by recent research is ascribed to bromoform. However, bromoform and chemically related compounds, when purified and in high doses, have been identified as a probable carcinogenic and as ozone-depleting. Therefore, there is a demand for natural sources containing these compounds for human and animal applications. For these reasons bromoform concentrations in livestock feed supplements must be carefully tested in vivo using breed specific, geographically localized and in measured proportions with respect to livestock feed total mix ratios (TMR).

Bromoform (CHBr₃) is a pale yellowish liquid with a sweet odor similar to chloroform, a halomethane or haloform. Bromoform's refractive index is 1.595 (20° C.). Small amounts are formed naturally by plants in the ocean. It is somewhat soluble in water however it readily evaporates into the air. Bromoform is one of the four haloforms, the others being fluoroform, chloroform, and iodoform. Natural production of bromoform by phytoplankton and seaweeds in the ocean is thought to be its predominant source in the environment.

Some of the highest concentrations of bromoform are produced in the red macroalgal genus Asparagopsis, where it is used as a chemical defense in the marine environment. Recently, Asparagopsis taxiformis and Asparagopsis armata (Harvey 1855) have been successfully used to inhibit the production of enteric methane in ruminants.

Research indicates that enteric methane output can be significantly reduced (from 80 to 98%) with no significant retention of the bromoform compounds in milk or meat in cattle. Several groups of scientists, including leading Australian researchers, found that there was benefit of adding Asparagopsis seaweed supplements to ruminant diet resulting in the reduction of methane production reaching over 80% in vivo studies and up to 99% in in vitro studies.

When included at a dosage of 2% of substrate organic matter in vitro, methane was reduced by >99% and when included at 0.2-5% of substrate organic matter in vivo, methane was reduced between 81 and 98% (Kinley, 2020). Importantly, these doses resulted in over 40% increases in weight gain and no negative effects on daily feed intake, feed conversion efficiencies, or rumen function, and no bromoform residues or changes in meat eating quality detected in beef cattle.

Dairy cows fed Asparagopsis at a 0.5% Organic Matter (OM) dose demonstrated no change in weight gain or milk productivity, while a higher dose of 1.0 OM inclusion led to both reduced weight gain and reduced milk production, indicating that the higher energy demands of lactating dairy cows require special consideration and management of dosing. More importantly than the % dosage used in those studies, is the concentration of bromoform in the biomass, which must remain above 1 mg g-1 organic matter for the biomass to maintain its efficacy and reduce methane by >99%, at least in vitro.

However, the inherent difficulty with a halogenated compounds such as bromoform, even as part of whole biomass, is that as an organic oil, bromoform can be lost to the environment through volatilization. Therefore, there is a need to develop innovative methods, with the fewest steps, for the processing of intact, fresh seaweed biomass, which maximize the concentration and longer-term retention of bromoform such that it can be harvested, processed and prepared for inclusion as a supplement for livestock feed without loss of quality through volatilization or otherwise impacted by chemical change during storage, transport, mixing and delivery.

### BRIEF DESCRIPTION OF THE DRAWING—DIAGRAM-1

The optimal method for processing of seaweed Asparagopsis species using fruit oil from olives or other fruits including coconut oil and argan oil includes steps presented in Diagram-1. This diagram presents a method to preserve, stabilize and store bromoform by homogenization of the seaweed biomass and includes: (1) Harvest, from natural, wild harvest or aquaculture open ocean or on-shore saltwater ponds using manual or mechanical means; (2) Water Washing, using water to remove sand, excess salt water, shells and small marine organisms and other materials that are not useful for inclusion in the homogenized end product; (3) Spin Drying, using mechanical centrifugal motion to reduce moisture content in the range of 800 rpm to 1,000 rpm; (4) Homogenizing spun dry Asparagopsis biomass in an optimal ratio of 1.2 kg biomass to 1.0 kg of olive oil or other fruit oil using a homogenizer capable of 10,000 to 30,000 rpm; (5) Screening Biomass with nylon mesh to reduce shredded biomass inclusion in final livestock feed supplement to insure standard dosage and product quality control; with the final stage of (6) Packing and Storing in air tight, food grade containers for shipment to integrated livestock feed processing and distribution. Packing should be performed in such a way to avoid excessive or intense exposure to light, or temperatures above 20° C. (68° F.).

### DETAILED DESCRIPTION OF THE INVENTION

The red seaweed Asparagopsis has been prepared in several ways to enable its inclusion in livestock feed as a supplement during the past several years of testing and research. The simplest method of preparing Asparagopsis seaweed for use as a feed supplement is to wild harvest the seaweed from its ocean habitat and to dry it in sunlight and open air. This includes collecting Asparagopsis from a near shore wild ocean habitat; washing the seaweed in fresh water to remove sand, saltwater, small shells and other marine organisms; then exposing the seaweed to sunshine and air to dry it prior to preparation in a shredded, pulverized powdered form for inclusion as a small fraction of the livestock feed. This simple method, while providing a low-carbon, low-cost approach to seaweed processing; has the significant drawback of loss of the most important active ingredients as the bromoform compounds will volatilize under these conditions and will not be available for its intended use.

A variation of this method is the use of large shipping container-size solar drying systems that enable bulk drying of seaweed and includes computer aided temperature-controlled drying with the use of solar powered fans and thermostatic controls to maintain a constant, uniform temperature. This drying method has a low carbon intensity and is capable of drying seaweed at optimal conditions of 28° tor 30° C. (82° to 86° F.) for 48 hours. However, the approach also results in bromoform compounds being volatized and therefore lost for effective use.

Another processing method used to better retain the content of antioxidants, phenols vitamins, and other bio-actives including bromoform compounds in natural products is freeze-drying. To date, freeze-drying biomass of Asparagopsis seaweeds also yields the highest concentration of bromoform compared with other solar drying processing methods. However, freeze-drying is energy-intensive and can be difficult and expensive to conduct on a large scale, at least from a logistical and energy perspective. A study comparing bromoform content of Asparagopsis immediately after harvest versus bromoform content after 12 weeks of storage has indicated as much as a 37% loss of bromoform using this freeze-drying method (Magnusson, 2020). Due to high costs and volatilization of bromoforms, this approach too has significant drawbacks.

A better alternative is to use a food-grade solvent, such as vegetable oil or fruit oil, that captures, retains, and prevents the degradation of bioactive compounds. Phytosterols, tocopherols, lipids, carotenoids and bromoforms can be preserved in such oils when stored at room temperature even with some exposure to light and oxygen. This is due to their esterification and, therefore, lipophilicity or the ability of a chemical compound to dissolve in fats, oils, lipids, and non-polar solvents. This is an effective way to preserve bromoform compounds and to reduce or eliminate volatilization after processing and storage, thus retaining the key active ingredients for improved results in reducing enteric methane production.

Lipophilic compounds also have higher partition coefficients (log KOW), a ratio measured by the difference in solubility in two immiscible liquids, which can range between −3 (extremely hydrophilic) and +10 (extremely lipophilic). Bromoform has a log KOW of +2.38 and partitioning from fresh algal biomass into the fruit oil infusion will reduce the losses of bioactive compounds through volatilization. While varietals of Olea europaea or Olive oil have slightly varying qualities due to differing environmental conditions and growing locations, most olive-fruit oils have a have an oil partition coefficient of approximately +1.00. This makes the selection of the olive fruit oil particularly well adapted for use in this novel application to stabilize and preserve bromoform metabolites in Asparagopsis seaweeds. This method enables the production of a livestock feed supplement that can be transported and stored at a range of temperatures without freezing enabling lower costs and a simpler, more effective production process.

Homogenization is the process of emulsifying two compounds such as fruit oil and Asparagopsis biomass and uniformly dispersing solid particles throughout a liquid. Benefits include improved product stability, uniformity, consistency, viscosity, and shelf life. Homogenization has become a standard industrial process in food and beverage, chemical, pharmaceutical and personal care industries. The stability of an emulsion is determined by several factors including the choice of emulsifier, the phase-volume ratio, the method of manufacturing the emulsion and the temperature in both processing and storage. Homogenization of bromoform compounds once released from the Asparagopsis cellular structures in which they are stored can be effectively mixed, infused, stored and distributed with little or no volatilization in fruit oils produced from olive, argan or coconut fruits. All of the mentioned fruit oils are produced in regions with ocean shorelines that presently have naturally occurring growth of Asparagopsis seaweeds.

Homogenizers are used to produce more consistent emulsions in a highly efficient process. A wide variety of homogenizers have been developed to run at different pressures and capacities depending on the product mixture. Suggested operational ranges for commercial scale homogenizers operated in the field typically run at variable speeds between 10,000 and 30,000 rpm. The energy release at these speeds causes turbulence and localized pressure differences which tear apart the biomass particles of Asparagopsis seaweed, releasing the bromoform compounds for smooth distribution into the fruit oil carrier.

Human use and domestication of the olive tree for fruit, food and oil in Europe dates back before present into the Bronze Age and beyond to about 19,000 years before present. The widespread use of olives and olive oil historically developed into a significant economic and trade factor in the ancient Mediterranean civilizations of Egypt, Knossos, Greece and Rome during the 3,000-year period of 2600 BC to 400 AD. Today approximately 90% of the global production of olive oil remains in southern Europe and the Mediterranean nations. Production over the past several hundred years has spread worldwide to the United States (primarily California), Australia and South Africa as well as Central and South American countries of Argentina, Brazil, Chile, Mexico, Peru and Uruguay.

The primary source of olive oil is the fruit of the olive tree (Olea europaea) and oil extracted from its 139 varietals of olive fruit cultivated worldwide. The olive, botanical name Olea europaea, meaning “European olive”, is a species of small tree in the family Oleaceae, found traditionally in the Mediterranean Basin. The species is cultivated in all the countries of the Mediterranean, as well as in Australia, New Zealand, North and South America and South Africa. Olea europaea is the type species for the genus Olea.

Initial wild harvest of Asparagopsis seaweeds was conducted in Portugal in 2021 by an international consortium of companies including Atlantic Ocean Aquaculture (AOA—US) NJORD AQtech As (Norway) and Mare Nostrum Ocean Technologies LDA (Portugal) in cooperation with research associates from the Nova University School of Medicine in Lisbon. The abundance of olive trees and significant olive oil industry in Portugal and Spain enable cost effective and low carbon access to olive oils from this region also in close proximity to seaweed harvest operations. There are ten (10) key olive fruit varietals of Olea europaea from this region that favor this as a principal geographic area of interest, testing and development. These olive fruit varietals in Portugal include Carrasquenha, Cobrangosa, Cordovil de Castelo Branco, Galega Vulgar, Galega, Maçanilha Algarvia, Redondil, Picual Verdeal and Madural and comparative testing of these will determine optimal choice of one or more of these olive fruit oils for use in the production and preservation of this livestock feed supplement.

Details on these varietals include: [1] Carrasquenha, originating from the north of the Alentejo Province, [2] Cobrangosa, from the Trás-os-Montes region that is largely used for olive oil production being rich in medium linoleic acid and polyphenols, [3] Cordovil olive oil from Castelo Branco due to its very rich oleic acid characteristics, [4] Galega Vulgar as it is the most common variety of olives in Portugal from Galega, Beiras, Alentejo and Algarve, [5] Galega that is 100% Portuguese and the most widespread olive oil in Portugal, [6] Maçanilha Algarvia because it is the main variety of the Algarve and it provides a medium yield of good quality olive oil, [7] Redondil which comes from the north of the Alentejo and has a high yield of olive oil characterized by an abundance of oleic acids, [8] Picual which is native of northern Portugal and the south of Spain and gives rise to fruits with a high yield of olive oil and represents about half of the Spanish olive trees and 20% of the rest of the worlds production. Its oil is rich in natural fatty acids and antioxidants and has a high presence of polyphenols. [9] Verdeal is well adapted to all Portuguese soil conditions, being frequent both in Alentejo and in Tris-os-Montes, and [10] Madural that is one of the rarest varieties of olive produced in Portuguese soil, Madural has a high yield in olive oil (>22%) and is very rich in linoleic acid.

### SUMMARY OF INVENTION

A red seaweed Asparagopsis when processed, homogenized in fruit oil and fed as a livestock feed supplement inhibits the production of enteric methane in ruminants. This novel art presents a method for use of naturally derived products in the form of fruit oils to be used in the effective preservation and stabilization of key ingredients using a specified method of preparation. Key bromoform compounds are found in Asparagopsis seaweeds in the form of secondary metabolites that can be extracted through a process of homogenization of the seaweed biomass in fruit oils to form a stable infusion that minimizes volatilization of the bromoforms during processing, storage and delivery thus improving product quality and effectiveness. Asparagopsis seaweeds exist in the general division of two species, Asparagopsis taxiformis, a tropical form of the seaweed and Asparagopsis armata, a form of the seaweed found in temperate ocean waters. A significant value of this product is its use to reduce the threat of climate change due to global warming. Methane is a powerful GHG and has contributed approximately 30% of all global warming since pre-industrial times and is now proliferating worldwide faster than at any time since recordkeeping began in the 1980's. Due to this product's intended end use for methane mitigation, the carbon footprint of the livestock feed supplement through the entire life cycle of production, processing and distribution is a key factor in the over effectiveness of its application as a carbon mitigation strategy in the form of a feed supplement for ruminants. The choice of its processing and preservation in a fruit-oil infusion is an apt choice as the occurrence and distribution of these referenced fruit oils is consistent with the geographic occurrence and distribution of Asparagopsis seaweeds in adjacent offshore waters. For example, olive fruit oils are produced in abundance in Portugal and Spain. Both of these nations have significant abundance of Asparagopsis armata in ocean ecosystems immediately adjacent to areas of olive tree growth and olive oil production. This fosters a favorable cost effective and low carbon supply chain. This is also true of the occurrence of Asparagopsis and olive oil production in California in the US, coconut fruit oil produced in India (Asparagopsis taxiformis) and corresponds with the near shore presence of Asparagopsis armata in coastal areas of Morocco matched with the indigenous production of argan oil. It is not only the chemical and physical qualities of the referenced fruit oils that provide for stabilization and preservation of the key bromoform compounds, but the effective use of these oils in concert with the abundant, adjacent occurrence and source of Asparagopsis in near shore ocean waters that supports the low cost and low carbon aspects of the total production value chain. The proposed process is simple, can be performed in near shore environments or can be adapted for production on ocean going vessels for effective and rapid processing and broad application to meet the substantial scaling requirements for global use and meaningful impact on methane reduction in ruminants worldwide.

What is claimed is:

1. A novel process for the production of a livestock feed supplement composed of Asparagopsis taxiformis or Asparagopsis armata seaweed homogenized in a fruit oil infusion in a manner that extracts bromoform compounds such that it can reduce enteric methane generation when fed to ruminants and is produced with the following steps:
(a) Harvesting the red seaweed biomass of Asparagopsis taxiforma or Asparagopsis armata from the ocean, a seaweed cultivated fishpond/onshore pond, indoor seaweed factory or open ocean aquaculture growing system;
(b) Wet washing the harvested Asparagopsis seaweed biomass to remove excess sea salt, shells and/or marine micro-organisms;
(c) Spin drying the washed Asparagopsis biomass to remove excess water;
(d) Homogenizing Asparagopsis biomass with olive fruit oil, oil from any of its varietals or alternative fruit oils at an optimal proportion of 1.2 parts spun dry biomass to 1.0 parts fruit oil;
(e) Screening biomass with nylon mesh to remove larger biomass particles from homogenized livestock feed supplement seaweed-fruit oil emulsion, extraction, mixture or infusion prior to or after shipment to livestock feed distributor; and
(f) Packing and storing the seaweed-fruit oil product in food grade, airtight, sealable containers for shipment and distribution.

2. The process of claim 1 wherein the addition of the spun dry red seaweed Asparagopsis armata or Asparagopsis taxiformis to olive fruit oil (Olea europaea) or oil from its varietals can be homogenized to produce an infusion that may be used as a livestock feed supplement to improve animal health and reduce its enteric methane output.

3. The process of claim 1 wherein the addition of the spun dry red seaweed Asparagopsis armata or Asparagopsis taxiformis to coconut oil (Cocos nucifera) or argan oil (Argania spinosa) oil or from its varietals can be homogenized to produce an infusion that may be used as a livestock feed supplement to improve animal health and reduce its enteric methane output.
